(19) United States
(12) Patent Application Publication
(10) Pub. No.: US 2026/0253977 A1
(43) Pub. Date: Aug. 27, 2026

(54) BATTERY, ELECTRICAL DEVICE, AND ASSEMBLY METHOD

(71) Applicant: SHENZHEN ENEXEED NEW ENERGY CO., LTD., Shenzhen (CN)

(72) Inventors: Xiangquan KONG, Shenzhen (CN); Liangxin YANG, Shenzhen (CN); Mingming HU, Shenzhen (CN)

(73) Assignee: SHENZHEN ENEXEED NEW ENERGY CO., LTD., Shenzhen (CN)

(21) Appl. No.: 18/861,606

(22) PCT Filed: Jul. 30, 2024
(86) PCT No.: PCT/CN2024/108554

§ 371 Date: Oct. 30, 2024

(30) Foreign Application Priority Data
Jul. 31, 2023 (CN) 202322047814.8
Jul. 31, 2023 (CN) 202322052731.8
Jul. 18, 2024 (CN) 202410962948.9

(51) Int. Cl. H01M 10/42; H01M 10/04; H01M 50/107; H01M 50/119; H01M 50/152; H01M 50/533; H01M 50/548

(52) U.S. Cl. CPC H01M 10/425; H01M 10/049; H01M 50/107; H01M 50/119; H01M 50/152; H01M 50/533; H01M 50/548

(57) ABSTRACT

Provided are battery, electrical device, and assembly method. Battery includes housing, battery core assembly, and controller. Housing defines accommodation chamber with opening end, wherein part of side wall of housing is recessed toward accommodation chamber, annular boss is formed on inner wall of housing; and position limitation part arranged along inner wall of opening end is arranged on one side of housing. Battery core assembly is accommodated in accommodation chamber, wherein one side of battery core assembly close to opening end abuts against one side of annular boss facing away from opening end. Controller is at least partially arranged in accommodation chamber and electrically connected to battery core assembly, wherein one end of controller close to the battery core assembly abuts against one side of annular boss facing away from battery core assembly, and one side of controller facing away from battery core assembly abuts against position limitation part.

### CROSS-REFERENCE TO RELATED APPLICATIONS

This application claims the priority of Chinese patent application No. 202410962948.9, filed with the Chinese Patent Office on Jul. 18, 2024, entitled “BATTERY AND ASSEMBLY METHOD”, the whole of which is incorporated herein by reference; this application claims the priority of Chinese patent application No. 202322052731.8, filed with the Chinese Patent Office on Jul. 31, 2023, entitled “BATTERY AND ELECTRICAL DEVICE”, part of which is incorporated herein by reference; and at the same time claims the priority of Chinese patent application No. 202322047814.8, filed with the Chinese Patent Office on Jul. 31, 2023, entitled “BATTERY AND ELECTRICAL DEVICE”, part of which is incorporated herein by reference.

### TECHNICAL FIELD

The present disclosure relates to the technical field of the battery, and in particular relates to a battery, an electrical device, and an assembly method.

### BACKGROUND ART

During the process of production and processing of the existing battery, since the battery includes multiple components, the procedure of the electrical connection process in the production and installation processes is relatively complex, which results in higher costs for the production and assembly and low efficiencies of the production and assembly of the battery.

### SUMMARY

In view of this, in order to overcome deficiencies in the prior art, the present disclosure provides a battery, an electrical device, and an assembly method.

In a first aspect, the present disclosure provides a battery, including:
a housing, defining an accommodation chamber with an opening end, wherein a part of a side wall of the housing is recessed toward the accommodation chamber; an annular boss is formed on an inner wall of the housing; and a position limitation part arranged along an inner wall of the opening end is arranged on one side of the housing;
a battery core assembly, accommodated in the accommodation chamber, wherein one side of the battery core assembly close to the opening end abuts against one side of the annular boss facing away from the opening end; and
a controller, at least partially arranged in the accommodation chamber and electrically connected to the battery core assembly, wherein one end of the controller close to the battery core assembly abuts against one side of the annular boss facing away from the battery core assembly, and one side of the controller facing away from the battery core assembly abuts against the position limitation part.

In some embodiments, the controller includes a control board and an electrode cap, and one side of the control board close to the battery core assembly is provided with at least one connector, wherein
the battery core assembly includes a battery core, and the connector is electrically connected to the battery core, wherein the electrode cap is protrudingly arranged on one side of the control board away from the battery core; the electrode cap passes through the opening end and a part of the electrode cap is located on an outer side of the opening end; a control circuit is arranged inside the control board; and the electrode cap is electrically connected to the connector by the control circuit.

In some embodiments, the connector abuts against a pole post of the battery core, and a steel shell of the battery core abuts against an inner sidewall of the housing.

In some embodiments, a conductive part is arranged on a periphery of the control board, wherein the conductive part is accessed to the control circuit, and the conductive part abuts against the inner sidewall of the housing.

In some embodiments, the battery core assembly includes an adaptor assembly, wherein
one end of the battery core close to the adaptor assembly is protrudingly provided with a first guide pin and a second guide pin with opposite polarities; the first guide pin and the second guide pin are both connected to the adaptor assembly; the connector abuts against the adaptor assembly and is electrically connected to the first guide pin by a first circuit arranged on the adaptor assembly; and the second guide pin is electrically connected to the housing by a second circuit arranged on the adaptor assembly.

In some embodiments, the adaptor assembly includes a secondary board and an adaptor ring, wherein the adaptor ring is connected to one side of the secondary board, and the adaptor ring is connected to the one end of the battery core close to the adaptor assembly, wherein the first guide pin and the second guide pin pass through the adaptor ring to connect to the secondary board; the first circuit and the second circuit are arranged on the secondary board; and the connector abuts against the secondary board, wherein the adaptor ring and the second circuit are conductive, and the adaptor ring abuts against the inner sidewall of the housing.

In some embodiments, the secondary board is provided with a first insertion hole and a second insertion hole, wherein the first guide pin is inserted into the first insertion hole to access to the first circuit, and the second guide pin is inserted into the second insertion hole to access to the second circuit.

In some embodiments, an abutting surface is arranged on one side of the secondary board close to the control board, wherein the abutting surface is accessed to the first circuit, and the connector abuts against the abutting surface.

In some embodiments, an elastic skirt is arranged on a periphery of the adaptor ring, wherein the elastic skirt is accessed to the second circuit, and the elastic skirt gradually expands from one end close to the battery core to one end close to the control board, wherein the elastic skirt abuts against the inner sidewall of the housing.

In some embodiments, the battery core assembly includes an adaptor and a position limitation member, wherein
the adaptor is arranged on one side of the battery core close to the controller; the position limitation member is arranged on one side of the adaptor facing away from the battery core; and one side of the adaptor facing away from the battery core abuts against the annular boss.

In some embodiments, the controller further includes a supporting member and an electrode sleeve, wherein
the supporting member is arranged on one side of the control board facing away from the battery core assembly; and
the electrode sleeve defines an accommodation space, and the control board and the supporting member are accommodated in the accommodation space respectively.

In some embodiments, the electrode sleeve includes an electrode ring and a second limiting ring, and the second limiting ring is arranged on one side of the electrode ring in an axis direction, wherein
the second limiting ring abuts against one side of the control board facing away from the supporting member, and an outer periphery of the control board and an outer periphery of the supporting member abut against an inner wall of the electrode ring respectively.

In some embodiments, the battery core and the controller are arranged at intervals to define a first chamber between the battery core, the controller, and the housing, wherein
the position limitation member is arranged in the first chamber, and the position limitation member is provided with at least one first through hole communicated with the first chamber.

In some embodiments, one side of the control board close to the battery core is provided with at least one connector, wherein
one end of the connector facing away from the control board passes through the position limitation member and is electrically connected to the battery core.

In some embodiments, the controller includes a charging interface, wherein the charging interface is connected to the control board, and the charging interface is arranged between the control board and the supporting member, wherein
a notch is arranged in the side wall of the housing, and an interface of the charging interface faces the notch.

In a second aspect, the present disclosure provides an assembly method for the battery, which is applied to the battery, wherein the assembly method includes:
acquiring the housing, the battery core assembly, and the controller;
loading: placing the housing to a fixed station;
installing the battery core assembly into the housing;
rolling a groove: pressing the housing to form a groove on a surface of the housing;
installing the controller into the housing; and
sealing: extruding an opening part of the housing, and inwardly folding part of the housing at the opening part to form a position limitation part.

In some embodiments, after placing the battery core assembly into the housing, it includes:
determining whether the battery core assembly is fixed at a preset position;
performing the step of rolling the groove, if yes; or adjusting a position of the battery core assembly or taking out the battery core assembly, if not.

In some embodiments, after the sealing, it further includes:
finished-product detection: detecting whether a voltage of the battery meets a preset voltage, wherein
the battery is qualified, if yes; or
the battery is unqualified, if not.

In a third aspect, the present disclosure provides an electrical device including the battery.

The embodiments of the present disclosure include the following beneficial effects. The battery is disposed to be the modularized housing, battery core assembly, and controller, so that the housing, the battery core assembly, and the controller can be individually produced respectively. Meanwhile, the installation difficulty of the battery can be reduced by reducing amounts of the modularization of the battery, so as to improve the production efficiency of the battery and to reduce the production and processing costs of the battery.

In order to make the above purposes, features, and advantages of the present disclosure more obvious and easier to understand, the following is a detailed description of preferred embodiments in conjunction with the drawings.

### BRIEF DESCRIPTION OF DRAWINGS

In order to more clearly illustrate the technical solutions in the embodiments of the present disclosure, the drawings to be used in the embodiments will be briefly introduced below. It should be understood that the following drawings only show certain embodiments of the present disclosure, and therefore should not be regarded as a limitation of the scope. For a person of ordinary skill in the art, other relevant drawings can be obtained according to these drawings without inventive efforts.

FIG. 1 shows an explosion diagram of one embodiment of a battery provided by some embodiments of the present disclosure;

FIG. 2 shows a sectional schematic diagram of one embodiment of a battery provided by some embodiments of the present disclosure;

FIG. 3 shows an explosion diagram of another embodiment of a battery provided by some embodiments of the present disclosure;

FIG. 4 shows a sectional schematic diagram of another embodiment of a battery provided by some embodiments of the present disclosure;

FIG. 5 shows a connection structure schematic diagram between a capacitive battery core and an adaptor assembly of another embodiment of a battery provided by some embodiments of the present disclosure;

FIG. 6 shows a disassembled schematic diagram of an adaptor assembly in another embodiment of a battery provided by some embodiments of the present disclosure;

FIG. 7 shows a structure schematic diagram at one angle of view of another embodiment of a battery provided by some embodiments of the present disclosure;

FIG. 8 shows an explosion diagram of another embodiment of a battery provided by some embodiments of the present disclosure;

FIG. 9 shows a structure schematic diagram of the other angle of view of another embodiment of a battery provided by some embodiments of the present disclosure;

FIG. 10 shows a sectional diagram of FIG. 9 at A-A part;

FIG. 11 shows a flow schematic diagram of an assembly method for a battery provided by some embodiments of the present disclosure;

FIG. 12 shows a flow schematic diagram of position detection for a battery core assembly in an assembly method for a battery provided by some embodiments of the present disclosure;

FIG. 13 shows a flow schematic diagram of voltage detection for a battery in an assembly method for a battery provided by some embodiments of the present disclosure; and FIG. 14 shows a flow schematic diagram of battery core assembly detection in an assembly method for a battery provided by some embodiments of the present disclosure.

### Main Reference Numbers

100—battery; 110—housing; 111—opening end; 112—closed end; 113—annular boss; 114—position limitation part; 115—annular roller groove; 116—notch; 117—first chamber; 120—control board; 121—connector; 122—electrode cap; 130—adaptor assembly; 131—secondary board; 1311—first insertion hole; 1312—second insertion hole; 1313—insertion groove; 132—adaptor ring; 1321—elastic skirt; 1322—insertion plate; 140—battery core; 141—first guide pin; 142—second guide pin; 143—pole post; 144—steel shell; 150—adaptor; 160—position limitation member; 161—first through hole; 170—supporting member; 180—electrode sleeve; 181—electrode ring; 182—second limiting ring; 190—accommodation space; 200—battery core assembly; 300—controller; and 400—charging interface.

### DETAILED DESCRIPTION OF EMBODIMENTS

The embodiments of the present disclosure are described in detail below. The examples of the embodiments are shown in the drawings, wherein the same or similar symbols throughout denote the same or similar components or components with the same or similar function. The embodiments described below referring to the drawings are exemplary and are intended only to explain the present disclosure and are not to be understood as a limitation of the present disclosure.

It should be noted that when a component is referred to be “fixed” to the other component, it can be directly arranged on the other component, or a centered component can exist. When a component is considered to be “connected” to the other component, it can be directly connected to the other component, or a centered component may exist at the same time. In contrast, when a component is referred to be “directly arranged on” another the component, the intermediate component does not exist. The terms “vertical”, “horizontal”, “left”, “right”, and similar expressions used herein are only illustrative.

In the present disclosure, unless other expressly specifications and limitations, the terms “mount”, “connect”, and “link” are to be understood in a broad sense, e.g., it can be a fixed connection, a detachable connection, or can be integral; it can be a mechanical connection or an electrical connection; it can be a direct connection, an indirect connection through an intermediate medium; and it can be a communication inside two components or interaction relationships between two components. For a person of ordinary skill in the art, the specific meaning of the above terms in the present disclosure may be understood according to specific situations.

Additionally, the terms of “first” and “second” are used only for descriptions and are not to be understood as indicating or implying a relative importance or implicitly specifying the number of technical features indicated. Therefore, a feature defined by “first” or “second” can expressly or implicitly include one or more such features. In the description of the present disclosure, “plurality” means two or more, unless otherwise expressly and specifically limited.

Unless otherwise defined, all technical and scientific terms used herein have the same meaning as commonly understood by those skilled belonging to the technical field of the present disclosure. The terms used herein in the specification of the template are only to describe specific embodiments and are not intended to limit the present disclosure. The term “and/or” used herein includes any and all combinations of one or more of the relevant listed items.

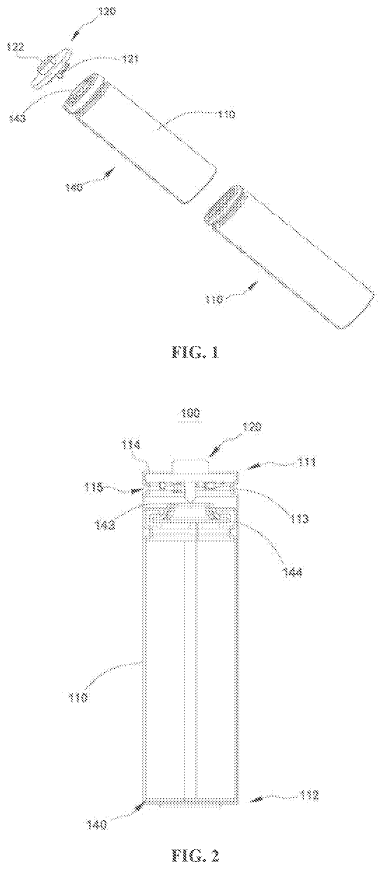

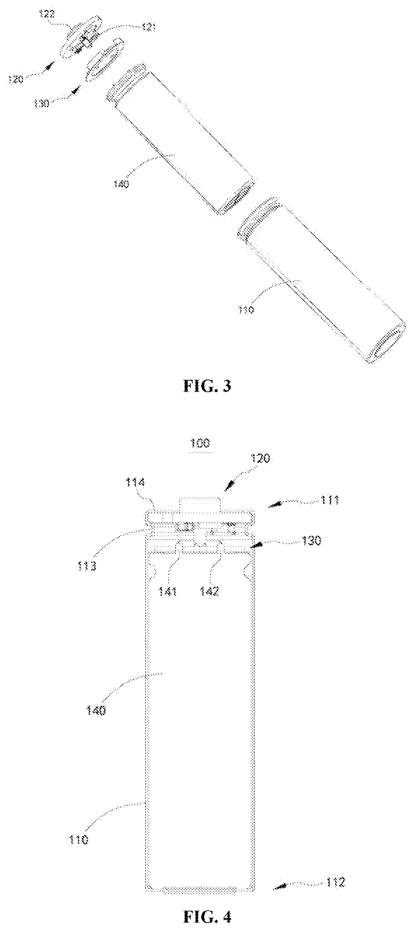

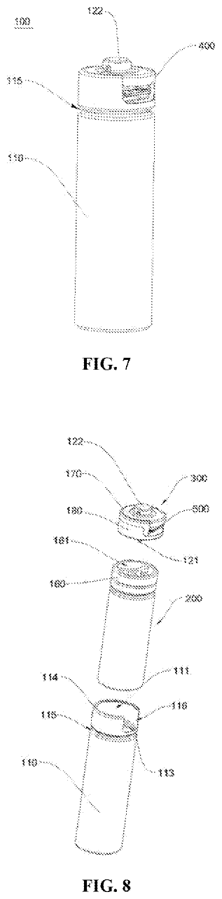

As shown in FIG. 1, FIG. 3, and FIG. 7, some embodiments of the present disclosure provide a battery, which is mainly used to reduce the difficulty of production and assembling the battery, and to improve the production efficiency and assembly efficiency of the battery.

The battery 100 includes a housing 110, a battery core assembly 200, and a controller 300.

The housing 110 defines an accommodation chamber with an opening end 111, wherein the shape of the housing 110 can be any one or a combination of two or more of cylindrical, polygonal, spherical, or ellipsoidal, which can be specifically set according to actual situations.

The shape of the housing 110 is cylindrical as an example for the following specific description in the present disclosure.

A part of a side wall of the housing 110 is recessed toward the accommodation chamber, wherein an annular boss 113 is formed on an inner wall of the housing 110, and an axis of the annular boss 113 coincides with an axis of the housing 110. It can be understood that the side wall of the housing 110 is recessed inwardly, so that an annular roller groove can be formed on an outer wall of the housing 110.

Additionally, a position limitation part 114 arranged along an inner wall of the opening end is arranged on one side of the housing 110. It can be understood that the position limitation part 114 is arranged on one side of the housing 110 in the axis direction. The position limitation part 114 is arranged on one side of the housing 110 close to the opening end, and the position limitation part 114 is connected to the inner wall of the housing 110, so as to form a flange close to the axis of the housing 110 on one side of the housing 110 in the axis direction. It should be noted that an axis of the position limitation part 114 coincides with the axis of the housing 110, wherein the position limitation part 114 can be any one of a limiting ring, a limiting arc, a limiting stop plate, a stopping ring arm, or a limiting stop bar.

Specifically, the annular boss 113 is close to the opening end, so as to ensure that the battery core assembly 200 can be accommodated in the accommodation chamber, and one end of the battery core assembly 200 close to the opening end abuts against one side of the annular boss 113 departing away from the opening end, so that the annular boss 113 can play a limiting effect on the battery core assembly 200 in the axis direction of the housing 110, so as to ensure the stability of the battery core assembly 200 in the accommodation chamber.

It is noted that the battery core assembly 200 abuts against the inner wall of the housing 110, so that the housing 110 plays a limiting effect on the battery core assembly 200 in a direction perpendicular to the axis of the housing 110. Additionally, one side of the battery core assembly 200 facing away from the controller 300 abuts against one end of the housing 110 away from the controller 300, so as to ensure the stability of the battery core assembly 200 in the accommodation chamber.

In the embodiment, a part of the side wall of the housing 110 is recessed toward the accommodation chamber to form the annular boss 113, so that the annular boss 113 plays the limiting and fixing effects on the battery core assembly 200 in an abutting method, so as to reduce the amount of the position limitation structures for the battery core assembly 200. Additionally, the design of the housing 110 being inwardly recessed not only can reduce the production cost of the battery, but also can simplify the position limitation structures for the battery core assembly 200, so as to improve the installation efficiency between the battery core assembly 200 and the housing 110 and the connection stability between the battery core assembly 200 and the housing 110, and to improve the production efficiency of the battery.

Further, the controller 300 is at least partially arranged in the accommodation chamber. It can be understood that in some embodiments, a part of the controller 300 is arranged in the accommodation chamber and another part of the controller 300 is located outside the accommodation chamber. In other embodiments, the controller 300 is completely accommodated in the accommodation chamber, which can be specifically set according to the actual situations.

Specifically, the controller 300 is electrically connected to the battery core assembly 200. It is noted that the connection methods between the controller 300 and the battery core assembly 200 include at least any one of a linear connection, a thimble-contact connection, and an inserting connection, which can be specifically set according to the actual situations.

One end of the controller 300 close to the battery core assembly 200 abuts against one side of the annular boss 113 facing away from the battery core assembly 200 to provide support to the controller 300 by one side of the annular boss 113 facing away from the battery core assembly 200, so as to ensure the stability of the controller 300 in the accommodation chamber.

Additionally, one side of the controller 300 facing away from the battery core assembly 200 abuts against the position limitation part 114 to limit one side of the controller 300 facing away from the battery core assembly 200 by the position limitation part 114, so as to further improve the stability of the controller 300 in the accommodation chamber. In the embodiment, the position limitation part 114 is formed by folding the edge of one end of the housing 110 close to the opening end toward a direction close to the accommodation chamber.

It is noted that in the axis direction of the housing 110, the position limitation part 114 and the annular boss 113 separately abut against two opposite sides of the controller 300 to provide the limiting effect to the controller 300, so to ensure the stability of the controller 300 along the axis direction of the housing 110. Additionally, the side wall of the controller 300 abuts against the inner wall of the housing 110 to limit the controller 300 along a direction perpendicular to the axis of the housing 110 by the housing 110, so to ensure the stability of the controller 300 in the accommodation chamber. It not only reduces the amount of the additional position limitation structures and connection structures for fixing the controller 300 to the housing 110, but also folds the edge of one end of the housing 110 close to the opening end towards the direction close to the accommodation chamber to form the position limitation part 114, which simplifies the fixing method and the fixing structure for the controller 300 and simplifies the installation structure of the battery, so as to reduce the production cost of the battery and to effectively improve the production efficiency of the battery.

In the present disclosure, the battery is disposed to be the modularized housing 110, battery core assembly 200, and controller 300, so that the housing 110, the battery core assembly 200, and the controller 300 can be individually produced respectively. Meanwhile, the installation difficulty of the battery can be reduced by reducing the amount of the modularization of the battery, so as to improve the production efficiency of the battery and to reduce the production and processing costs of the battery.

It is worth noting that in the embodiment, the housing 110 is a conductive housing.

As shown in FIG. 1, FIG. 3 and FIG. 7, in some embodiments of the present disclosure, the controller includes a control board and an electrode cap, wherein one side of the control board 120 close to the battery core assembly 200 is provided with at least one connector 121.

It is noted that in the embodiment, one or two connectors 121 can be provided.

The battery core assembly 200 includes a battery core 140, wherein the connector is electrically connected to the battery core.

The electrode cap 122 is protrudingly arranged on one side of the control board 120 away from the battery core 140; the electrode cap 122 passes through the opening end 111 and a part of the electrode cap 122 is located on an outer side of the opening end 111; a control circuit is arranged inside the control board 120; and the electrode cap 122 is electrically connected to the connector 121 by the control circuit.

Exemplarily, when one connector 121 is provided, one end of the connector 121 facing away from the control board 120 abuts against a first electrode end of the battery core 140 to form an electrical connection.

Exemplarily, when two connectors 121 are provided, two connectors 121 include a first connector 121 and a second connector 121, wherein the first connector 121 is connected to a first connection end of the battery core 140, and the second connector 121 is connected to a second connection end of the battery core 140.

One end of the connector 121 facing away from the control board 120 passes through the position limitation member 160 and is electrically connected to the battery core 140.

It is to be noted that the connection methods between the connector 121 and the battery core 140 include abutting fit, inserting fit, or snapping fit, which can be specifically set according to the actual situations.

Specifically, in the embodiment, the connector 121 is connected to the battery core 140 by means of abutting fit, which simplifies the connection structure between the connector 121 and the battery core 140, and also simplifies the connection difficulty between the battery core 140 and the connector 121, so as to improve the connection efficiency between the battery core 140 and the connector 121, thereby improving the production efficiency of the battery core assembly 200 and the production efficiency of the battery.

As shown in FIG. 1 and FIG. 2, in the embodiment, the housing 110 is provided with the opening end 111 and a closed end 112; the control board 120 and the battery core 140 both are accommodated in the housing 110 and are arranged in sequence from the opening end 111 to the closed end 112; and the connector 121 is protrudingly arranged on one side of the control board 120 close to the battery core 140, wherein the connector 121 abuts against a pole post 143 of the battery core 140, and the steel shell 144 of the battery core 140 abuts against the inner sidewall of the housing 110.

In the embodiment, the housing 110 is cylindrical, and its two ends are the opening end 111 and the closed end 112 respectively. The control board 120 and the battery core 140 are arranged in sequence from the opening end 111 to the closed end 112, which means that the control board 120 and the battery core 140 are arranged in sequence on the axis of the housing 110, wherein the control board 120 is closer to the opening end 111 and the battery core 140 is closer to the closed end 112.

The battery core 140 is the conventional component on the market, and the pole post 143 is arranged on one end of the battery core 140 close to the control board 120, wherein the end face of the pole post 143 abuts against the connector 121 of the control board 120 to establish an electrical connection, and the steel shell 144 of the battery core 140 is electrically connected to the housing 110.

In the embodiment, the pole post 143 of the battery core 140 has a positive polarity, and the steel shell 144 has a negative polarity. It is to be understood that a control circuit is arranged inside the control board 120, and the control circuit plays a role of voltage regulation and grounding. The connector 121 is accessed to the control circuit, so that the positive electrode of the battery core 140 is accessed to the control circuit through that the connector 121 abuts against the pole post 143 of the battery core 140. A conductive part is arranged on a periphery of the control board 120, wherein the conductive part is accessed to the control circuit, and the conductive part abuts against the inner sidewall of the housing 110, so that the control circuit is electrically connected to the steel shell 144 of the negative electrode on the battery core 140.

In another embodiment, the pole post 143 of the battery core 140 can also have the negative polarity, and the steel shell 144 has the positive polarity. In this case, the negative electrode of the battery core 140 is accessed to the control circuit through that the connector 121 abuts against the pole post 143, and the positive electrode of the battery core 140 is accessed to the control circuit through that the conductive part abuts against the housing 110.

Specifically, the connector abuts against the pole post of the battery core, and the electrode cap 122 is electrically connected to the pole post 143 of the battery core 140. It can be seen that in the battery 100 provided by the embodiment, the electrode cap 122 is the positive electrode, and the housing 110 is the negative electrode. In the embodiment that the pole post 143 of the battery core 140 has the negative polarity and the steel shell 144 has the positive polarity, the electrode cap 122 of the battery 100 is the negative electrode and the housing 110 is the positive electrode.

As shown in FIG. 1 and FIG. 2, when the battery 100 provided by the embodiment is assembled, the battery core 140 and the control board 120 are only needed to load into the housing 110 in sequence. In it only necessary to ensure that the pole post 143 of the battery core 140 faces the opening end 111, and the connector 121 of the control board 120 faces the closed end 112.

After the battery core 140 is loaded into the housing, its steel shell 144 abuts against the inner sidewall of the housing 110 to establish the electrical connection. After the control board 120 is loaded into the housing, its connector 121 abuts against the pole post 143 of the battery core 140, so as to establish the electrical connection between the control circuit and the positive electrode of the battery core 140; and the conductive part on the control board 120 abuts against the side wall of the housing 110, so as to establish the electrical connection between the control circuit and the negative electrode of the battery core 140.

In the embodiment, the opening end 111 is folded inwardly to form the position limitation part 114, wherein the position limitation part 114 and the annular boss 113 are arranged at intervals and clamp the control board 120 together, and the connector 121 crosses the annular boss 113 to abut against the pole post 143 of the battery core 140.

The annular boss 113 is between the control board 120 and the battery core 140, and the annular boss 113 is obtained by roller pressing the outer side wall of the housing 110, i.e., an annular roller groove 115 is formed on a position on the outer side wall of the housing 110 corresponding to the annular boss 113. In practical use, in order to facilitate loading the battery core 140 into the housing, the operation of roller pressing to form the annular boss 113 is carried out after the battery core 140 is loaded into the housing, which avoids the annular boss 113 to hinder the battery core 140 from loading into the housing.

After the battery core 140 is loaded into the housing and pressed to form the annular boss 113, the control board 120 is loaded into the housing 110 from the opening end 111 until the control board 120 circumferentially abuts against the annular boss 113, wherein its connector 121 is just ensured to abut against the pole post 143 of the battery core 140 through presetting sizes. In this state, the opening end 111 is folded inwardly to form the position limitation part 114, wherein the position limitation part 114 abuts against one side of the control board 120 facing away from the annular boss 113, i.e., the position limitation part 114 and the annular boss 113 clamp and fix the control board 120 together.

It can be understood that during the process of folding the opening end 111 to form the position limitation part 114, it needs to ensure that the inner edge of the position limitation part 114 is not in contact with the electrode cap 122 to avoid the short circuit for the positive electrode and the negative electrode. In other words, in the embodiment, there is a gap between the electrode cap 122 and the position limitation part 114.

In order to further reduce the assembly difficulty and improve the assembly accuracy, in the embodiment, the control board 120, the battery core 140, and the housing 110 are arranged coaxially, wherein the control board 120 circumferentially abuts against the inner sidewall of the housing 110; the outer side wall of the battery core 140 circumferentially abuts against the inner sidewall of the housing 110; the connector 121 is arranged on the axis of the housing 110; and the pole post 143 of the battery core 140 is arranged on its axis.

As can be seen, since the sizes are preset in advance, after the battery core 140 and the control board 120 are sequentially loaded into the housing 110 when assembling, it can ensure that the connector 121 is automatically aligned and abuts against the pole post 143 of the battery core 140, which eliminates the alignment for a second time, so as to significantly reduce the assembly difficulty and to improve the assembly accuracy.

In summary, in the battery 100 provided by the embodiment, only one connector 121 is arranged on the control board 120 by applying the battery core 140, wherein the electrical connection between the positive electrode of the battery core 140 and the control circuit is established through that the pole post 143 of the battery core 140 abuts against the connector 121, and the electrical connection between the negative electrode of the battery core 140 and the control circuit is established through that the steel shell 144 of the battery core 140 abuts against the housing 110. Therefore, the battery 100 provided by the embodiment has features of the simple structure and easy assembly.

As shown in FIG. 3 to FIG. 6, in the embodiment, the battery core assembly includes the adaptor assembly. The housing 110 is provided with the opening end 111 and the closed end 112, wherein the control board 120, the adaptor assembly 130, and the battery core 140 are all accommodated in the housing 110 and are arranged in sequence from the opening end 111 to the closed end 112. One end of the battery core 140 close to the adaptor assembly 130 is protrudingly provided with a first guide pin 141 and a second guide pin 142 with opposite polarities, wherein the first guide pin 141 and the second guide pin 142 are both connected to the adaptor assembly 130. One side of the control board 120 close to the adaptor assembly 130 is protrudingly provided with the connector 121, wherein the connector 121 abuts against the adaptor assembly 130 and is electrically connected to the first guide pin 141 by a first circuit arranged on the adaptor assembly 130, and the second guide pin 142 is electrically connected to the housing 110 by a second circuit arranged on the adaptor assembly 130.

In the embodiment, the housing 110 is cylindrical, and its two ends are the opening end 111 and the closed end 112 respectively. The control board 120, the adaptor assembly 130, and the battery core 140 are arranged in sequence from the opening end 111 to the closed end 112, which means that the control board 120, the adaptor assembly 130, and the battery core 140 are arranged in sequence on the axis of the housing 110, wherein the control board 120 is closest to the opening end 111 and the battery core 140 is closest to the closed end 112, and the adaptor assembly 130 is between the control board 120 and the battery core 140.

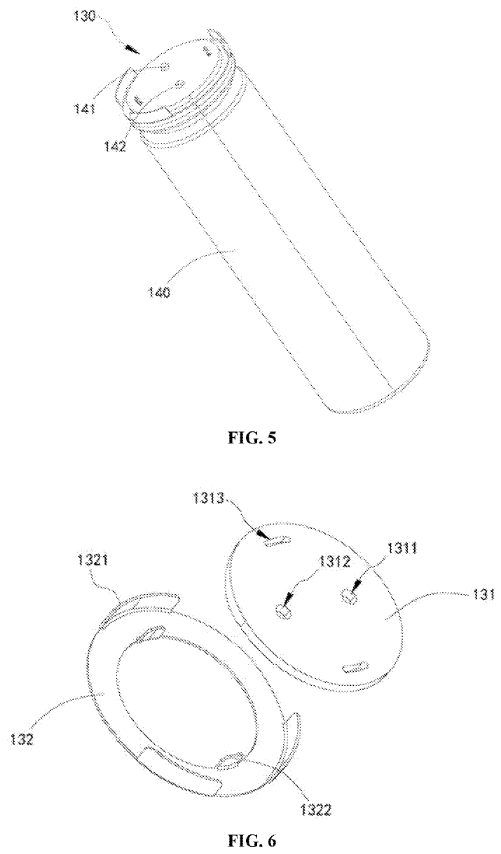

In fact, in the embodiment, besides the connections between the first guide pin 141 and the second guide pin 142 and the adaptor assembly 130, one end of the battery core 140 close to the adaptor assembly 130 is further connected to the adaptor assembly 130. In conjunction with FIG. 5, FIG. 5 shows a schematic diagram of the connection structure between the battery core 140 and the adaptor assembly 130.

Before loading, the adaptor assembly 130 is connected to one end of the battery core 140 that is protrudingly provided with the first guide pin 141 and the second guide pin 142 firstly, and the first guide pin 141 is connected to the adaptor assembly 130 to access to the first circuit, so that the second guide pin 142 is connected to the adaptor assembly 130 to access to the second circuit. Later, the entire structure composed of the adaptor assembly 130 and the battery core 140 is loaded into the housing 110 from the opening end 111 together, and it ensures that the adaptor assembly 130 is closer to the opening end 111.

After the entire structure composed of the adaptor assembly 130 and the battery core 140 is loaded into the housing 110 together, the adaptor assembly 130 abuts against the inner sidewall of the housing 110, so that the second guide pin 142 is electrically connected to the housing 110 automatically. Later, the control board 120 is loaded into the housing 110 from the opening end 111 until its connector 121 abuts against the adaptor assembly 130, and therefore the electrical connection between the first guide pin 141 and the control board 120 can be completed.

It can be understood that the control circuit playing roles of the voltage regulation and grounding is arranged inside the control board 120, wherein the conductive part is arranged on the periphery of the control board 120, and both the conductive part and the connector 121 are accessed to the control circuit. In the state that the control board 120 is loaded into the housing 110, its connector 121 abuts against the adaptor assembly 130, so that the first guide pin 141 is electrically connected to the control circuit, and the conductive part arranged at the periphery abuts against the inner sidewall of the housing 110, so that the control circuit is electrically connected to the second guide pin 142.

The electrode cap 122 is protrudingly arranged on one side of the control board 120 away from the adaptor assembly 130, wherein the electrode cap 122 extends out of the opening end 111, and the electrode cap 122 is electrically connected to the connector 121 by the control circuit. The first guide pin 141 and the second guide pin 142 have opposite polarities. In the practical use, if the first guide pin 141 has the positive polarity, the second guide pin 142 has the negative polarity, i.e., the electrode cap 122 is the positive electrode of the battery 100, and the housing 110 is the negative electrode of the battery 100. Conversely, if the first guide pin 141 has the negative polarity, the second guide pin 142 has the positive polarity, i.e., the electrode cap 122 is the negative electrode of the battery 100, and the housing 110 is the positive electrode of the battery 100.

For the fixing of the control board 120, in the embodiment, the opening end 111 is folded inwardly to form the position limitation part 114, wherein the position limitation part 114 and the annular boss 113 are arranged at intervals and clamp the control board 120 together, and the connector 121 crosses the annular boss 113 to abut against the adaptor assembly 130.

The annular boss 113 is located between the control board 120 and the adaptor assembly 130 and is obtained by circumferentially roller pressing the outer side wall of the housing 110. In the practical use, in order to facilitate the assembly, the operation of roller pressing the housing 110 to form the annular boss 113 is carried out after the battery core 140 and the adaptor assembly 130 are integrally loaded into the housing, which avoids the annular boss 113 from preventing loading of the battery core 140 and the adaptor assembly 130 into the housing.

After the annular boss 113 is molded, the control board 120 is loaded into the housing 110 from the opening end 111 until circumferentially abutting against the annular boss 113. Later, the opening end 111 is folded inwardly to form the position limitation part 114, wherein the position limitation part 114 abuts against one side of the control board 120 facing away from the annular boss 113, i.e., the position limitation part 114 and the annular boss 113 clamp and fix the control board 120 together. It can be understood that during the process of folding the opening end 111 to form the position limitation part 114, it needs to ensure that the inner edge of the position limitation part 114 is not in contact with the electrode cap 122 to avoid the short circuit for the positive electrode and the negative electrode.

In conjunction with FIG. 6, FIG. 6 shows a disassembled schematic diagram of the adaptor assembly 130.

In the embodiment, the adaptor assembly 130 includes a secondary board 131 and an adaptor ring 132. The adaptor ring 132 is connected to one side of the secondary board 131, and the adaptor ring 132 is connected to one end of the battery core 140 close to the adaptor assembly 130. The first guide pin 141 and the second guide pin 142 pass through the adaptor ring 132 to connect to the secondary board 131, and the first circuit and the second circuit are arranged on the secondary board 131, wherein the connector 121 abuts against the secondary board 131; the adaptor ring 132 and the second circuit are conductive; and the adaptor ring 132 abuts against the inner sidewall of the housing 110.

One side of the adaptor ring 132 away from the battery core 140 is protrudingly provided with an insertion plate 1322; the secondary board 131 is provided with an insertion groove 1313; and the insertion plate 1322 is inserted into the insertion groove 1313. It can be understood that in the state that the insertion plate 1322 is inserted into the insertion groove 1313, the adaptor ring 132 is accessed to the second circuit arranged on the secondary board 131 In order to ensure that the insertion plate 1322 is firmly inserted to the insertion groove 1313, in the embodiment, the insertion plate 1322 is in an arc shape, and the insertion groove 1313 is correspondingly a stripe hole extending in shape of the arc. Further, in order to ensure that two insertion plates 1322 and two insertion grooves 1313 are provided, two insertion plates 1322 are symmetrically distributed on the adaptor ring 132; two insertion grooves 1313 are centrally symmetrical on the secondary board 131; and two insertion plates 1322 are correspondingly inserted to two insertion grooves 1313.

In the embodiment, one side of the adaptor ring 132 facing away from the secondary board 131 is welded to the end wall of one end of the battery core 140 protrudingly provided with the first guide pin 141 and the second guide pin 142. In another embodiment, according to the practical application condition, the adaptor ring 132 can be connected to the battery core 140 by another connection methods such as adhering.

The secondary board 131 is provided with a first insertion hole 1311 and a second insertion hole 1312, wherein the first guide pin 141 is inserted into the first insertion hole 1311 to access to the first circuit, and the second guide pin 142 is inserted into the second insertion hole 1312 to access to the second circuit.

The abutting surface is arranged on one side of the secondary board 131 close to the control board 120, wherein the abutting surface is accessed to the first circuit, and the connector 121 abuts against the abutting surface. It can be understood that the first guide pin 141 is inserted into the first insertion hole 1311 and the connector 121 abuts against the secondary board 131, which eliminates the alignment and connection between the connector 121 and the first guide pin 141, so as to significantly reduce the assembly difficulty.

In order to ensure the reliable abutment between the adaptor ring 132 and the inner sidewall of the housing 110, in the embodiments, an elastic skirt 1321 is arranged on the periphery of the adaptor ring 132, wherein the elastic skirt 1321 is accessed to the second circuit, and the elastic skirt 1321 gradually expands from one end close to the battery core 140 to one end close to the control board 120, wherein the elastic skirt 1321 abuts against the inner sidewall of the housing 110.

In order to ensure that the elastic skirt 1321 can smoothly deform when abutted by the inner sidewall of the housing 110 and avoid from preventing the adaptor assembly 130 from loading into the housing, the elastic skirt 1321 in the embodiment is a segmented structure. It can be understood that before the adaptor ring 132 is loaded into the housing, the inner edge diameter of the elastic skirt 1321 is smaller than the inner diameter of the housing 110, which ensures that the adaptor ring 132 can smoothly enter the opening end 111. The outer edge diameter of the elastic skirt 1321 is larger than the inner diameter of the housing 110, which ensures that the elastic skirt 1321 can reliably abut against the inner sidewall of the housing 110 during the process of loading into the housing, so as to ensure that second guide pin 142 reliably abuts against the housing 110.

In summary, the battery 100 provided by the embodiment uses the battery core 140 and introduces the adaptor assembly 130, wherein the first guide pin 141 of the battery core 140 and the connector 121 of the control board 120 are conductive by the adaptor assembly 130, and the second guide pin 142 and the housing 110 are conductive; and the first guide pin 141 and the second guide pin 142 are accessed to the control circuit through the electrical connection between the control board 120 and the housing 110, which eliminates the arrangement of positive and negative tabs on the control board 120, wherein two connectors 121 are separately aligned and connected to the positive and negative tabs of the battery core, thereby simplifying the overall structure and reducing the assembly difficulty.

As shown in FIG. 8, the battery core assembly 200 further includes the adaptor 150 and the position limitation member 160.

The adaptor 150 is arranged on one side of the battery core 140 close to the controller 300, wherein the connection method between the adaptor 150 and the battery core 140 includes any one of adhering, snapping, or welding, which can be specifically set according to the actual situations. In the embodiment, the adaptor 150 is connected to the battery core 140 by welding to improve the strength and stability of the connection.

It is noted that the battery core 140 can be any one or a combination of two and more of cylindrical, polygonal, spherical, or ellipsoidal. In the embodiment, the following specification is given by taking an example that the battery core 140 is cylindrical.

In the embodiment, the adaptor 150 is connected to the battery core 140 by welding to improve the connection stability between the adaptor 150 and the battery core 140. It is noted that the axis of the adaptor 150 coincides with the axis of the battery core 140.

Additionally, the position limitation member 160 is arranged on one side of the adaptor 150 facing away from the battery core 140, and one side of the adaptor 150 facing away from the battery core 140 abuts against the annular boss 113, so that the annular boss 113 plays the limiting effect on the adaptor 150, so as to limit the battery core 140. It can be understood that the position limitation member 160 is arranged between the annular boss 113 and the adaptor 150, so that the annular boss 113 and the adaptor 150 play the limiting effect on the position limitation member 160, so as to ensure the stability of the position limitation member 160 in the accommodation chamber. The connection method of abutting can reduce the assembly difficulty between the battery core assembly 200 and the housing 110, and improve the assembly efficiency between the battery core assembly 200 and the housing 110.

Specifically, the connection method between the position limitation member 160 and the adaptor 150 includes any one of adhering, snapping, threaded connection, lap, or integral molding.

In the embodiment, the position limitation member 160 is connected to the adaptor 150 by means of lap to facilitate the installation and the disassemble, so to reduce the connection difficulty between the position limitation member 160 and the adaptor 150, and reduce the processing procedure of the battery core assembly 200, thereby improving the production efficiency of the battery core assembly 200.

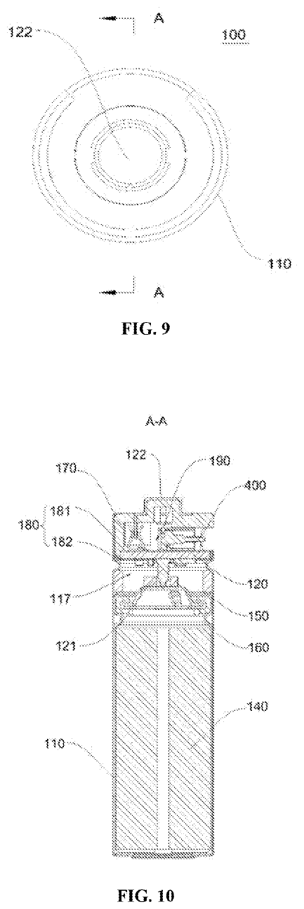

As shown in FIG. 8 to FIG. 10, in some embodiments of the present disclosure, the controller 300 includes the control board 120, supporting member 170, electrode sleeve 180, and the electrode cap 122.

The supporting member 170 is arranged on one side of the control board 120 facing away from the battery core assembly 200, and the electrode cap 122 is arranged on one side of the supporting member 170 facing away from the control board 120, so as to support and limit the electrode cap 122 by the supporting member 170, wherein one end of the electrode cap 122 passes through the supporting member 170 to electrically connect to the control board 120.

It is noted that in the embodiment, the supporting member 170 is an insulating structure, wherein the supporting member 170 plays the role of insulating and isolation between the electrode cap 122 and the electrode sleeve 180.

Additionally, the electrode sleeve 180 defines an accommodation space 190, wherein the control board 120 and the supporting member 170 are accommodated in the accommodation space 190 respectively, and the edge of the control board 120 abuts against the electrode sleeve 180, so that the control board 120 is electrically connected to the electrode sleeve 180. The controller 300 is arranged in the accommodation chamber, and the side wall of the controller 300 abuts against the inner wall of the housing 110. That is to say, in the embodiment, the outer wall of the electrode sleeve 180 abuts against the inner wall of the housing 110, so that the electrode sleeve 180 is electrically connected to the housing 110, and thereby the control board 120 is electrically connected to the housing 110.

It is to be noted that the edge of the control board 120 is abutted against the inner wall of the electrode sleeve 180, so that the heat generated by the control board 120 in the operation process can be conducted to the electrode sleeve 180; and the heat is emitted by the electrode sleeve 180, so as to realize the heat dissipation for the control board 120. It can be understood that the edge of the control board 120 is connected to the inner wall of the electrode sleeve 180, so as to improve the contact area between the control board 120 and the electrode sleeve 180; and the rate of heat conduction between the control board 120 and the electrode sleeve 180 is improved, so as to improve the efficiency of heat dissipation for the control board 120.

Exemplarily, if the electrode cap 122 is the positive electrode end of the battery, the housing 110 serves as the negative electrode end of the battery; and if the electrode cap 122 is the negative electrode end of the battery, the housing 110 serves as the positive electrode end of the battery.

As shown in FIG. 10, in some embodiments of the present disclosure, the electrode sleeve 180 includes the electrode ring 181 and the second limiting ring 182, and the second limiting ring 182 is arranged on one side of the electrode ring 181 in the axis direction, wherein the electrode ring 181 and the second limiting ring 182 are molded by integral connection to improve the overall strength of the electrode sleeve 180. Additionally, the axis of the electrode ring 181 coincides with the axis of the second limiting ring 182.

Specifically, the second limiting ring 182 abuts against one side of the control board 120 facing away from the supporting member 170, so that the second limiting ring 182 plays the role of limiting and supporting on the control board 120 in the axis direction of the electrode sleeve 180, so as to ensure the stability of the control board 120 and the supporting member 170 in the electrode sleeve 180.

Additionally, the outer periphery of the control board 120 and the outer periphery of the supporting member 170 abut against the inner wall of the electrode ring 181 respectively, so that the electrode ring 181 limits the control board 120 and the supporting member 170 in the direction perpendicular to the axis of the electrode sleeve 180, so as to avoid the control board 120 and the supporting member 170 from swaying in the accommodation space 190, thereby ensuring the connection stability between the control board 120, the supporting member 170, and the electrode sleeve 180, so as to ensure the stability of the controller 300.

It can be understood that the controller 300 provided by the present disclosure can be produced individually and can be moved or assembled as a whole. The modularization of the controller 300 facilitates the production, transportation, or assembly, which reduces the difficulties of production and assembling for the battery, so as to improve the production and assembly efficiency of the battery, which reduces the battery assembly deviation or defective rate, so as to improve the production quality of the battery.

It should be noted that the electrode sleeve 180 is made of a conductive material.

As shown in FIG. 10, in some embodiments of the present disclosure, the battery core 140 and the controller 300 are arranged at intervals to define a first chamber 117 between the battery core 140, the controller 300, and the housing 110, so that the first chamber 117 can play the role of pressure relief and buffering to the battery core assembly 200, which avoids the bulging of the battery in use, so as to ensure the safety and stability of the battery in use.

The position limitation member 160 is arranged in the first chamber 117, and the position limitation member 160 is provided with at least one first through hole 161 communicated with the first chamber 117. It is to be understood that the number of the first through holes 161 can be one, two, or the number of any value of more than two, which can be specifically set according to the actual situations.

Specifically, the side wall of the position limitation member 160 abuts against the inner wall of the housing 110, so that the housing 110 plays the limiting effect on the position limitation member 160 in the direction perpendicular to the axis of the battery.

It is noted that the position limitation member 160 is a fixing ring, wherein the fixing ring is an insulating member to provide the elastic support and limiting effects to the battery core 140 by the position limitation member 160, so as to ensure the stability of the battery core 140 in the accommodation chamber. The position limitation member 160 is disposed to be an elastic insulating member, so that the elastic insulating member can play a role of elastic shrinkage adjustment during the process of a part of the side wall of the housing 110 recessing inwardly, so as to ensure the stability of the battery core assembly 200 in the accommodation chamber, which avoids the damage to the position limitation member 160 during processing, thereby ensuring the production quality of the battery.

As shown in FIG. 7 and FIG. 8, in some embodiments of the present disclosure, the controller 300 includes a charging interface 400, wherein the charging interface 400 is electrically connected to the control board 120, and the charging interface 400 is arranged between the control board 120 and the supporting member 170, so that the supporting member 170 plays the limiting and protection effects to the charging interface 400.

Specifically, a notch 116 is arranged in the side wall of the housing 110, wherein an interface of the charging interface 400 faces the notch 116, and a caliber of the notch 116 is larger than a caliber of the interface, so that the external connection end can connect to the interface of the charging interface 400 by the notch 116, and therefore the control board 120 is electrically connected to the external power source.

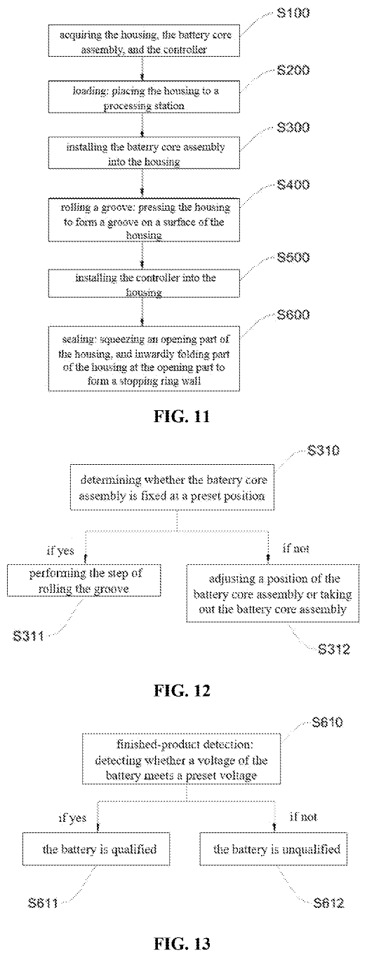

As shown in FIG. 11, some embodiments of the present disclosure provide an assembly method for the battery, which is applied in the battery described in any one of the above embodiments, wherein the assembly method includes the following steps.

Step S100: acquiring the housing, the battery core assembly, and the controller.

The acquired housing 110 is a cylindrical housing 110. A circular opening end is cut on one side of the cylindrical housing 110 in the axis direction by cutting or drilling, so that the axis of the opening end coincides with the axis of the cylindrical housing 110. It is noted that the housing 110 is a hollow cylinder structure, so that the battery core assembly 200 and the controller 300 can be installed to the interior of the housing 110 through the opening end.

Step S200: loading: placing the housing to a processing station.

It is to be noted that in the embodiment, the processing stations can be one, two, or any value of more than two, which can be specifically set according to the actual situations.

Exemplarily, the housing 110 is placed to the processing stations of a hopper, wherein the hopper has a plurality of processing stations arranged in the array. It can be understood that a plurality of housings 110 can be separately placed to the processing stations of the hopper at the same time, so as to assemble a plurality of batteries, thereby further improving the assembly efficiency for the batteries.

Additionally, the number of the hopper can also be one, two, or any value of more than two, which can further improve the number of batteries to be assembled, and improve the assembly efficiency.

Step S300: installing the battery core assembly into the housing.

Specifically, the battery core assembly 200 is gripped from the picking station by the gripping mechanism, and the battery core assembly 200 is inserted into the housing 110 through the opening end.

The battery core assembly 200 includes the core 140, the adaptor 150, and the position limitation member 160, wherein the adaptor 150 is installed on one side of the battery core 140 in a length direction by welding.

In the embodiment, the battery core 140 provided with the adaptor 150 is inserted into the housing 110 through the opening end by the gripping mechanism; and then the position limitation member 160 is gripped by the gripping mechanism, and the position limitation member 160 is inserted into the housing 110 through the opening end, wherein the axis of the position limitation member 160 is ensured to coincide with the axis of the housing 110. The position limitation member 160 abuts against the adaptor 150 by pressing down on the position limitation member 160, so that the battery core assembly 200 is installed to the housing 110.

Step S400: rolling the groove: pressing the housing to form a groove on a surface of the housing.

Specifically, the housing 110 is pressed by a hob, and the housing 110 or the hob is rotated around the axis of housing 110 at the same time. A part of housing 110 is pressed in the axis direction of the housing 110 by the hob to form a groove on the outer surface of the housing 110, and the annular boss 113 is formed on the inner surface of the housing 110 at the same time.

Step S500: installing the controller into the housing.

Specifically, the controller 300 is clamped by a clamping mechanism, and the controller 300 is installed in the housing 110. The connector 121 arranged on the controller 300 is abutted against the battery core 140 in the battery core assembly 200 by pressing down the controller 300, so as to form the electrical connection.

Step S600: sealing: extruding the opening end part of the housing, and inwardly folding part of the housing at the opening end part to form the position limitation part.

In the embodiment, part of the housing 110 located at the opening end part is folded inwardly in a mold extrusion method to form the position limitation part 114; and the edge of one side of the controller 300 facing away from the battery core assembly 200 is wrapped, so as to fix the controller 300 into the housing 110.

Specifically, the controller 300 includes the control board 120, and the side wall of the control board 120 abuts against the inner wall of the housing 110, so that the negative electrode of the controller 300 is electrically connected to the housing 110.

As shown in FIG. 12, in some embodiments of the present disclosure, after placing the battery core assembly 200 into the housing, it includes the following steps.

Step 310: determining whether the battery core assembly is fixed at a preset position.

Specifically, the insulation detection head is pressed down by the cylinder; and it is to determine whether the battery core assembly 200 in the housing 110 is placed in place by utilizing the height difference, wherein the battery core assembly 200 is determined to be unqualified whether it is higher or lower than the preset height.

Step S311: performing the step of rolling the groove, if yes.

It can be understood that if the battery core assembly 200 satisfies the preset height, the position and the height of the battery core assembly 200 installed in the housing 110 are both qualified, and step S400 can be performed.

Step S312: adjusting the position of the battery core assembly or taking out the battery core assembly, if not.

It can be understood that if the height of the battery core assembly 200 in the housing 110 is larger or smaller than the preset height, the position and height of the battery core assembly 200 are unqualified, so that the position of the battery core assembly 200 in the housing 110 is adjusted, or the battery core assembly 200 is removed and reinstalled.

As shown in FIG. 14, in some embodiments of the present disclosure, before rolling the groove, it includes the following steps.

Step S320: detecting the voltage and internal resistance of the battery core assembly, and determining whether the battery core assembly is qualified.

Specifically, the detection head is pressed down by the cylinder; and the voltage/internal resistance of the battery core assembly 200 is detected by a four-wire clamp in contact with the positive and negative electrodes of the battery core assembly 200. It is determined to be unqualified if the voltage is lower than the set value, and it is determined to be unqualified if the internal resistance is larger than the set value.

Step S321: detecting whether the voltage of the battery core assembly is larger than the set value.

Exemplarily, a digital voltmeter or multimeter can be connected to the positive electrode and negative electrode of the battery core assembly 200 to determine whether the voltage of the battery core assembly 200 is larger than the set value, wherein the battery core assembly 200 is qualified, if yes; it is unqualified, if not.

Step S322: detecting whether the internal resistance of the battery core assembly is larger than the set value.

Additionally, an internal resistance tester is connected to the positive electrode and negative electrode of the battery core assembly 200 to detect a measurement of the internal resistance of the battery core assembly 200, so as to determine whether the internal resistance of the battery core assembly 200 is larger than the set value, wherein it is unqualified, if yes; it is qualified, if not.

In some embodiments of the present disclosure, before the sealing, it further includes a step of pre-sealing: the clamp structure clamps the groove of the battery to pre-seal the opening end part of the battery.

Specifically, the loosening of the controller 300 can be avoided through the pre-sealing in the movement process of the battery before sealing, so as to ensure the packaging and processing qualities of the battery.

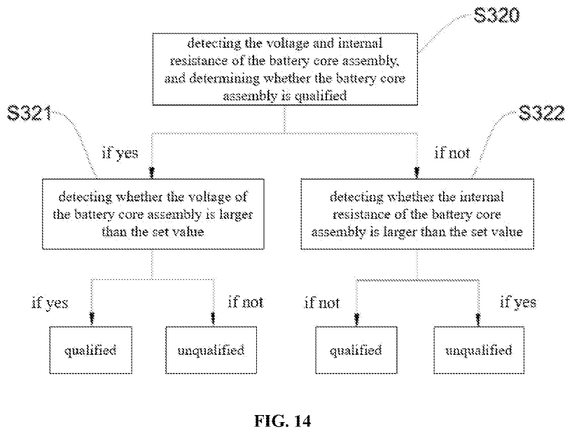

As shown in FIG. 13, in some embodiments of the present disclosure, after the sealing, it further includes the following steps.

Step S610: finished-product detection: detecting whether the voltage of the battery meets the preset voltage.

Specifically, the digital voltmeter or multimeter can be connected to the positive electrode and negative electrode of the battery to determine whether the voltage of the battery is larger than the set value.

Step S611: the battery is qualified, if yes.

It can be understood that if the voltage of the detected battery meets the preset voltage, the battery is the qualified product.

Step S612: the battery is unqualified, if not.

It can be understood that if the voltage of the detected battery does not meet the preset voltage, the battery is the unqualified product.

For the assembly method for the battery provided by the present disclosure, the assembly and position limitation are realized in a physical snapping method, which can not only improve the assembly efficiency of the battery, but also simplify the assembly difficulty of the battery, so as to reduce the assembly cost of the battery, and improve the assembly efficiency of the battery.

Additionally, in some embodiments of the present disclosure, after step S600, it further includes a load test for the battery. It should be noted that the load test is a test carrying out under the condition that the battery is provided with the simulate actual load, which is used to test the output performance of the battery. The output stability of the battery is evaluated by the test, so as to ensure the production quality of the battery.

The present embodiment further provides an electrical device, wherein the electrical device includes the foregoing battery 100. The electrical device provided by the present embodiment has the feature of a lower cost of use due to the beneficial effect of the battery 100.

In all examples shown and described herein, any specific value should be only interpreted as exemplary and not as a limitation. Therefore, other examples of the exemplary embodiments may have different values.

It should be noted that similar symbols and letters denote similar items in the following drawings. Therefore, once an item has been defined in one of the drawings, it does not need to be further defined and explained in subsequent drawings.

The above embodiments only show several embodiments of the present disclosure, and their descriptions are more specific and detailed, but cannot therefore be understood as limiting the scope of the present disclosure. It should be noted that for a person of ordinary skill in the art, several deformations and improvements can be made without facing away from the conception of the present disclosure, all of which fall within the scope of protection of the present disclosure.

1. A battery, comprising:
a housing, defining an accommodation chamber with an opening end, wherein a part of a side wall of the housing is recessed toward the accommodation chamber; an annular boss is formed on an inner wall of the housing, and a position limitation part arranged along an inner wall of the opening end is arranged on one side of the housing;
a battery core assembly, accommodated in the accommodation chamber, wherein one side of the battery core assembly close to the opening end abuts against one side of the annular boss facing away from the opening end; and
a controller, at least partially arranged in the accommodation chamber and electrically connected to the battery core assembly, wherein one end of the controller close to the battery core assembly abuts against one side of the annular boss facing away from the battery core assembly, and one side of the controller facing away from the battery core assembly abuts against the position limitation part.

2. The battery according to claim 1, wherein the controller comprises a control board and an electrode cap, and one side of the control board close to the battery core assembly is provided with at least one connector, wherein
the battery core assembly comprises a battery core, and the connector is electrically connected to the battery core, wherein
the electrode cap is protrudingly arranged on one side of the control board away from the battery core; the electrode cap passes through the opening end and a part of the electrode cap is located on an outer side of the opening end; a control circuit is arranged inside the control board; and the electrode cap is electrically connected to the connector by the control circuit.

3. The battery according to claim 2, wherein the connector abuts against a pole post of the battery core, and a steel shell of the battery core abuts against an inner sidewall of the housing.

4. The battery according to claim 2, wherein a conductive part is arranged on a periphery of the control board, wherein the conductive part is accessed to the control circuit, and the conductive part abuts against an inner sidewall of the housing.

5. The battery according to claim 2, wherein the battery core assembly comprises an adaptor assembly, wherein
one end of the battery core close to the adaptor assembly is protrudingly provided with a first guide pin and a second guide pin with opposite polarities; the first guide pin and the second guide pin are both connected to the adaptor assembly; the connector abuts against the adaptor assembly and is electrically connected to the first guide pin by a first circuit arranged on the adaptor assembly; and the second guide pin is electrically connected to the housing by a second circuit arranged on the adaptor assembly.

6. The battery according to claim 5, wherein the adaptor assembly comprises a secondary board and an adaptor ring, wherein the adaptor ring is connected to one side of the secondary board, and the adaptor ring is connected to one end of the battery core close to the adaptor assembly, wherein the first guide pin and the second guide pin pass through the adaptor ring to connect to the secondary board; the first circuit and the second circuit are arranged on the secondary board; and the connector abuts against the secondary board, wherein the adaptor ring and the second circuit are conductive, and the adaptor ring abuts against the inner sidewall of the housing.

7. The battery according to claim 6, wherein the secondary board is provided with a first insertion hole and a second insertion hole, wherein the first guide pin is inserted into the first insertion hole to access to the first circuit, and the second guide pin is inserted into the second insertion hole to access to the second circuit.

8. The battery according to claim 6, wherein an abutting surface is arranged on one side of the secondary board close to the control board, wherein the abutting surface is accessed to the first circuit, and the connector abuts against the abutting surface.

9. The battery according to claim 6, wherein an elastic skirt is arranged on a periphery of the adaptor ring, wherein the elastic skirt is accessed to the second circuit, and the elastic skirt gradually expands from one end close to the battery core to one end close to the control board, wherein the elastic skirt abuts against the inner sidewall of the housing.

10. The battery according to claim 2, wherein the battery core assembly comprises an adaptor and a position limitation member, wherein
the adaptor is arranged on one side of the battery core close to the controller; the position limitation member is arranged on one side of the adaptor facing away from the battery core; and one side of the adaptor facing away from the battery core abuts against the annular boss.

11. The battery according to claim 10, wherein the controller further comprises a supporting member and an electrode sleeve, wherein
the supporting member is arranged on one side of the control board facing away from the battery core assembly; and
the electrode sleeve defines an accommodation space, and the control board and the supporting member are accommodated in the accommodation space respectively.

12. The battery according to claim 11, wherein the electrode sleeve comprises an electrode ring and a second limiting ring, and the second limiting ring is arranged on one side of the electrode ring in an axis direction, wherein
the second limiting ring abuts against one side of the control board facing away from the supporting member, and an outer periphery of the control board and an outer periphery of the supporting member abut against an inner wall of the electrode ring respectively.

13. The battery according to claim 11, wherein the battery core and the controller are arranged at intervals to define a first chamber between the battery core, the controller, and the housing, wherein
the position limitation member is arranged in the first chamber, and the position limitation member is provided with at least one first through hole communicated with the first chamber.

14. The battery according to claim 11, wherein one side of the control board close to the battery core is provided with at least one connector, wherein
one end of the connector facing away from the control board passes through the position limitation member and is electrically connected to the battery core.

15. The battery according to claim 11, wherein the controller comprises a charging interface, wherein the charging interface is connected to the control board, and the charging interface is arranged between the control board and the supporting member, wherein
a notch is arranged in the side wall of the housing, and an interface of the charging interface faces the notch.

16. An assembly method for a battery, applicable to the battery according to claim 1, wherein the assembly method comprises:
acquiring a housing, a battery core assembly, and a controller, loading: placing the housing to a fixed station;
installing the battery core assembly into the housing;
rolling a groove: pressing the housing to form a groove on a surface of the housing;
installing the controller into the housing; and
sealing: extruding an opening part of the housing, and inwardly folding part of the housing at the opening part to form a position limitation part.

17. The assembly method for the battery according to claim 16, wherein after placing the battery core assembly into the housing, comprising following steps:
determining whether the battery core assembly is fixed at a preset position;
performing the step of rolling a groove, if yes; or
adjusting a position of the battery core assembly or taking out the battery core assembly, if not.

18. The assembly method for the battery according to claim 16, wherein after the sealing, further comprising following steps:
finished-product detection: detecting whether a voltage of the battery meets a preset voltage, wherein
the battery is qualified, if yes; or
the battery is unqualified, if not.

19. An electrical device, comprising the battery according to claim 1.

20. The electrical device according to claim 19, wherein the controller comprises a control board and an electrode cap, and one side of the control board close to the battery core assembly is provided with at least one connector, wherein
the battery core assembly comprises a battery core, and the connector is electrically connected to the battery core, wherein
the electrode cap is protrudingly arranged on one side of the control board away from the battery core; the electrode cap passes through the opening end and a part of the electrode cap is located on an outer side of the opening end; a control circuit is arranged inside the control board; and the electrode cap is electrically connected to the connector by the control circuit.
